(19) United States
(12) Patent Application Publication
(10) Pub. No.: US 2025/0145807 A1
(43) Pub. Date: May 8, 2025

(54) STYRENE BUTADIENE RUBBER COMPOSITION WITH LANOLIN FATTY ACIDS AND METALS SALTS

(71) Applicant: FERMENTA BIOTECH LIMITED, Thane West (IN)

(72) Inventors: Anupama DATLA, Mumbai (IN); Prashant NAGRE, Thane West (IN); Jagdish TAMORE, Thane West (IN); Kishor AMBAWADE, Mumbai (IN); Mohammad Kausar SHAIKH, Mumbai (IN)

(21) Appl. No.: 18/837,513

(22) PCT Filed: Feb. 11, 2023
(86) PCT No.: PCT/IN2023/050139

§ 371 Date: Aug. 9, 2024

(30) Foreign Application Priority Data
Feb. 11, 2022 (IN) 202221007406

(51) Int. Cl. C08L 9/06; C08K 3/04; C08K 3/06; C08K 5/3437; C08K 5/40; C08K 5/47; C11B 11/00

(52) U.S. Cl. CPC C08L 9/06; C08K 3/04; C08K 3/06; C08K 5/3437; C08K 5/40; C08K 5/47; C11B 11/005

(57) ABSTRACT

The present invention discloses styrene butadiene rubber (SBR) composition containing the by-products based on renewable source such as calcium salt of lanolin fatty acid (CA), magnesium salt of lanolin fatty acids, pretreated calcium salt of lanolin fatty, lanolin fatty acids like crude (CLFA) and bleached lanolin fatty acids (BLFA) and process thereof.

### FIELD OF THE INVENTION

The present invention relates to styrene butadiene rubber (SBR) composition containing the by-products based on renewable source such as calcium salt of lanolin fatty acid (CA), magnesium salt of lanolin fatty acids, pretreated calcium salt of lanolin fatty, lanolin fatty acids like crude (CLFA) and bleached lanolin fatty acids (BLFA) and process thereof.

### BACKGROUND OF THE INVENTION

The diene type rubber, such as natural rubber (NR), styrene-butadiene rubber (SBR) and butadiene rubber (BR), is known as a rubber excellent in dynamic fatigue resistance and dynamic characteristics. Due to environmental changes, there is a need or the heat resistance and weather resistance of the rubber products. However, there has been hitherto no such rubber that retains superior mechanical characteristics, fatigue resistance and dynamic characteristics the conventional diene type rubber provides and in addition that possesses good weather resistance. There have heretofore been made various studies on blend type rubber compositions comprising a diene type rubber which has excellent mechanical characteristics, dynamic fatigue resistance and dynamic characteristics. Accordingly, emergence of a novel rubber material is desired which has excellent heat resistance and in addition which has mechanical characteristics, dynamic characteristics and fatigue resistance equal or superior to the diene type rubber.

The lanolin fatty acids and their salts are comprised of saturated, unsaturated, branched including methyl and ethyl, alpha and omega hydroxy with branching and having carbon chain length from C8 to C40. These different classes compounds in give diverse applications. The Crude and Bleached lanolin fatty acids have similar physical properties except colour and these properties could be resembling to Stearic acid, which is being used as activator, dispersing agent, plasticizer and lubricating agents in styrene butadiene rubber compounding. Compared the properties based on the sample from each per hundred rubber prototype formulations. The SBR rubber is being used exclusively in various application like tyre, conveyor belts, rubber sheets for different uses, etc.

Moreover, in SBR rubber composition the stearic acid and zinc oxide is exclusively used as activator along with the other gradients like carbon, sulfur, preservatives, anitoxidents, etc. In situ there could be chance of the formation of metallic soap during the rubber processing like milling, etc.

The lanolin fatty acids are being produced from wool grease by alkaline hydrolyses, separation of soap and acidulation, washing and drying or hydrolysis of calcium soap of lanolin fatty acids or other metallic soaps like magnesium soap of lanolin fatty acids or magnesium salt of lanolin fatty acids or aluminium salt or soap of lanolin fatty acids or transesterification of wool grease with lower chain alcohols like methanol or Isopropanol or butanol, and separation by molecular distillation unit (SPDU) and then alkaline hydrolysis washing and drying, or column chromatographic separation of alkyl esters and followed by alkaline hydrolysis, acidulation, washing and drying. Chemically they are varied in their carbon chain length exclusively ranging from C8 to C40 with different classes like saturated straight chain, unsaturated straight chain, methyl branched (Iso), ethyl branched (Anti Iso), alfa hydroxy methyl branched, alpha hydroxy ethyl branched, omega methyl branched, and omega ethyl branched. These different structural qualities of lanolin fatty acids attribute diverse application in various industries like cosmetic, personal care, soap and detergent, lubricants, grease, paints, plastic, paper, leather, rubber.

In view of the same, the present inventors envisaged evaluating calcium salt of lanolin fatty acid (CA), magnesium salt of lanolin fatty acids, pretreated calcium salt of lanolin fatty acid, lanolin fatty acids like crude (CLFA) and bleached lanolin fatty acids (BLFA) in styrene butadiene rubber (SBR) composition and using such by-products based on renewable source and cost effective with respect to stearic and zinc oxide in SBR composition/formulation for various industrial applications. This remains the objective of the invention.

### SUMMARY OF THE INVENTION

In accordance with the above, the present invention provides rubber composition comprising
1. A diene rubber;
2. By-products based on renewable source selected from calcium salt of lanolin fatty acid (CA), magnesium salt of lanolin fatty acids, pretreated calcium salt of lanolin fatty or crude lanolin fatty acids (CLFA) and bleached lanolin fatty acids (BLFA) alone or mixtures thereof; and
3. Additives.

The diene rubber is selected from natural rubber (NR), styrene-butadiene rubber (SBR) and butadiene rubber (BR) and the like; preferably the rubber is SBR.

In another aspect, the present invention provides the process for the rubber composition with by-products based on renewable source selected from calcium salt of lanolin fatty acid (CA), magnesium salt of lanolin fatty acids, pretreated calcium salt of lanolin fatty or crude lanolin fatty acids (CLFA) and bleached lanolin fatty acids (BLFA) alone or mixtures thereof and suitable additives.

In another aspect, the present invention provides the evaluation of by-products based on renewable source such as calcium salt of lanolin fatty acid (CA) or magnesium salt of lanolin fatty acids (MG) or pretreated calcium salt of lanolin fatty (CAW) or crude lanolin fatty acids (CLFA) and bleached lanolin fatty acids (BLFA) in rubber composition.

### DESCRIPTION OF THE FIGURES

FIG. 1: Process flow diagram for pretreatment of calcium salt of lanolin fatty acids.

### DESCRIPTION OF THE INVENTION

The invention will now be described in detail in connection with certain preferred and optional embodiments, so that various aspects thereof may be more fully understood and appreciated.

The principal objective of the invention to evaluate by-products, which have been produced in the process of cholesterol isolation from wool grease in the prototype formulation based on Styrene Butadiene Rubber (SBR) compounding as an activator, dispersing agent, plasticizer and lubricating agent. This invention relates the fully replacement of stearic acid by crude lanolin fatty acids or/and bleached lanolin fatty acid. It also relates the fully replacement of stearic acid and Zinc oxide by calcium and magnesium salts of lanolin fatty acids and pretreated calcium salt of lanolin fatty acids in styrene butadiene rubber compounding. In order to achieve similar rheological and mechanical properties of SBR rubber compounding as stearic acid possesses and/or combination of stearic acid and zinc oxide.

The present inventors found out that the by-products based on renewable source such as calcium, magnesium and pretreated calcium salts of lanolin fatty acids play similar role as the stearic acid plays in commercial rubber articles like tyre, conveyor belt, rubber sheets, etc with no disadvantages as seen for the use of stearic acid and zinc oxide. Thus the performance evaluation has been executed individually by designing a prototype-per hundred rubber formulations against stearic and zinc oxide-based prototype per hundred rubber formulation and compared the rheological and mechanical properties.

Accordingly, the present invention discloses rubber composition comprising
i. A diene rubber selected from natural rubber (NR), styrene-butadiene rubber (SBR) or butadiene rubber (BR);
ii. By-products based on renewable source selected from calcium salt of lanolin fatty acid (CA), magnesium salt of lanolin fatty acids, pretreated calcium salt of lanolin fatty or crude lanolin fatty acids (CLFA) and bleached lanolin fatty acids (BLFA) alone or mixtures thereof; and
iii. Additives which include but not restricted to Carbon Black, Aromatic Oil, Antioxidants, Accelerators and Curing Agent.

In a preferred embodiment, the present invention relates to styrene butadiene rubber (SBR) composition comprising;
1. Styrene butadiene rubber in an amount of 100 per hundred rubber (Nearly 51.54% of total formulation)
2. By-products based on renewable source selected from calcium salt of lanolin fatty acid (CA), magnesium salt of lanolin fatty acids (MG), pretreated calcium salt of lanolin fatty (CAW) or crude lanolin fatty acids (CLFA) and bleached lanolin fatty acids (BLFA) in an amount of 0.5 to 5.0%, and 1.0 to 6% per hundred rubbers, respectively, alone or mixtures thereof; and
3. Additives in an amount of 40 to 47% per hundred rubbers

The preferably percentage of calcium salts or calcium soap of lanolin fatty acid and magnesium salt of magnesium soap of lanolin fatty acids are 0.5 to 5% per hundred rubbers, preferably 1 to 4% more preferably 2 to 4%. Similarly, the percentage of pretreated calcium salt or calcium soap of lanolin fatty acids is 0.5 to 5%, preferably 1 to 4 and more preferably 2 to 4%.

In all these formulations the other components/ingredients include but is not limited to N326 (Carbon Black), Aromatic Oil (Aro.oil), Antioxidant TDQ, Accelerator CBS, Accelerator TMTD and Curing Agent Sulphur to achieve desired rheological and mechanical properties.

In an embodiment, the SBR rubber composition comprises lanolin fatty acids, 1 to 6% of lanolin fatty acids in per hundred rubber as activator, preferably 2 to 6%, more preferably 2 to 4% along with other components/ingredients which include but is not limited to N326 (Carbon Black), Aro. Oil, Antioxidant TDQ, Accelerator CBS, Accelerator TMTD and Curing Agent Sulphur.

Lanolin or wool grease or wool wax is being produced as a by-product of wool processing on alkaline hydrolysis of lanolin in the presence of lower chain alcohol preferably methanol and caustic potash and/or caustic soda at elevated temperature. After accomplishment of alkaline hydrolysis, such reaction mass, comprises of potassium and/or sodium salt of lanolin fatty acid, unreacted free alkali, lower chain alcohol-methanol, and the lanolin alcohols. The salt of lanolin fatty acids present in solution is converted into metallic soap or calcium soap of lanolin fatty acids or calcium salt of lanolin fatty acids using an equivalent quantity of calcium chloride dehydrated through double decomposition process, which occurs at relatively low temperature than alkaline hydrolysis. On filtration process, the metallic soap or calcium soap of lanolin fatty acids or calcium salt of lanolin fatty acids (CaLFA) along with little quantity of inorganic salt gets separated out as solid on filter media.

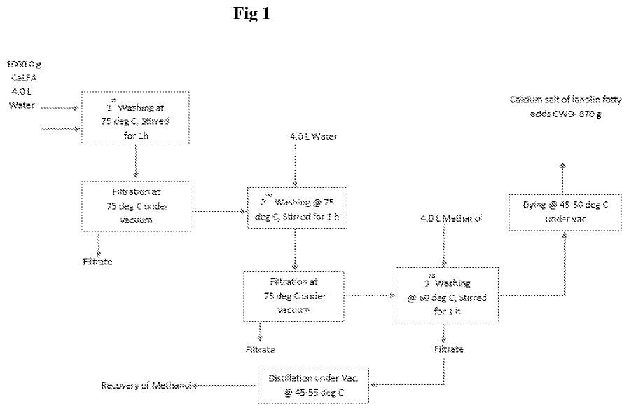

These solid are further used after drying as starting material for production of lanolin fatty acids or as is used for different applications or washed with water to remove water soluble salts and subsequently drying to get rid of trace of water. The details of the pretreatment of calcium salt of lanolin fatty acid are given in the FIG. 1. The analysis of washed and dried calcium salt of lanolin fatty acids or calcium soap or metallic soap of lanolin fatty acids is tabulated in the Table 1 below.

TABLE 1
Analysis of washed and dried Calcium salt of lanolin
fatty acids or calcium soap of lanolin fatty acid:

| Sr | | |
|---|---|---|
| No. | Parameters | Results |
| 1 | Appearance | Light brown |
| | | powder |
| 2 | Free Fatty Acid (%) | 0.66 |
| 3 | Moisture (%) | 0.38 |
| 4 | Ash Content as CaO (%) | 7.09 |
| 5 | Calcium Content (%) | 5.1 |

In another embodiment, the present invention disclose magnesium salt of lanolin fatty acids or magnesium soap of lanolin fatty acids in styrene butadiene rubber composition The same is synthesized in laboratory starting with the distilled lanolin fatty acids and the detail of the production is given below in the example.

In yet another embodiment, the present invention disclose bleached crude lanolin fatty acids for compounding in SBR. In the chemical bleaching process, the material is heated to 80 to 85 deg C. to get a clear liquid under constant stirring. A pre-decided bleaching reagent and its quantity is administrated at certainly rate into the molten mass for at least 6 to 10 hours, preferably 8 hours in order to allow the nascent oxygen to react with color imparting constituents of the crude lanolin fatty acids. Eventually, the drying is carried out after bleaching process to get negligible peroxide value (less than 20 ppm or 20 mEq/kg).

In another embodiment, the distilled lanolin fatty acids are being produced using a molecular distillation unit especially short path distillation unit (SPDU) under moderately reduced pressure less than 0.001 mbar at 200 to 260 deg C. since lanolin fatty acids are comprised of different carbon chain length with high molecular weight and unable to distill out by fractionating column under reduced pressure at elevated temperature.

In another embodiment, the present invention relates to the evaluation of by-products based on renewable source such as Calcium salt of lanolin fatty acid (CA) or magnesium salt of lanolin fatty acids or pretreated calcium salt of lanolin fatty or crude lanolin fatty acids (CLFA) and bleached lanolin fatty acids (BLFA) in SBR composition. The rheological and mechanical properties of SBR rubber composition comprising calcium salt or calcium soap of lanolin fatty acids, magnesium salt or magnesium soap of lanolin fatty acid and pretreated calcium salt or calcium soap of lanolin fatty acids were evaluated as per the standard protocols against the stearic acid and zinc oxide.

Accordingly, SBR per hundred rubber formulation based on stearic acid and zinc oxide with known quantity along with other ingredients was developed as control. The uncured and cured properties of control formulation were evaluated as per standard protocols. The uncured rheological properties using Montech Rheometer (MDR-3000) at 160° C. as per ASTM D5289., Mooney viscosity using a Prescott Mooney Viscometer at 100° C. as per ASTM D1646 and Mooney scorch time using Prescott Mooney Viscometer at 125° C. as per ASTM D1646, and vulcanized molding time at 160° C., and the cured mechanical properties using Instron Universal Testing Machine, as per ASTM D412 and ASTM D624 were determined.

The present SBR rubber composition with Calcium salt of lanolin fatty acid (CA) or magnesium salt of lanolin fatty acids or pretreated calcium salt of lanolin fatty or crude lanolin fatty acids (CLFA) and bleached lanolin fatty acids (BLFA) showed improved modulus, tensile strength, elongation property, hardness and tear strength as compared to the SBR rubber composition containing stearic acid and zinc oxide.

The invention will now be described in the following specific examples, however, it is being understood that the particulars shown are solely for purpose of illustrative discussion of preferred embodiments of the invention.

### EXAMPLES

The rheological properties—the cure characteristics of the formulations were studied as per ASTM D5289, in a Montech Rheometer (MDR-3000) at 160° C. The curing characteristics of the materials, expressed in terms of the scorch time (tS2), Induction time (tS1), optimum cure time (t90), the maximum and minimum values of the torque (MH and ML respectively). Mooney viscosity of all the formulations were tested using a Prescott Mooney Viscometer at 100° C. The testing procedure was conducted according to the method described in ASTM D1646. Mooney scorch time (t5) was determined by using Prescott Mooney Viscometer at 125° C. as per ASTM D1646. The Mooney scorch time (t5) is defined as the time required for an increase of five units above the minimum viscosity and determined from a plot of the Mooney viscosity versus time. Tested the mechanical properties of the cured styrene butadiene rubber composition sample from each formulation. For testing properties on vulcanized rubber compounds, rubber slab and other samples were cured at 160° C. as per curing protocol. All the molded samples are free from visible defects. Molded samples were precondition at room temperature before further testing.

### Example 1

Bleached Lanolin Fatty Acid (BLFA) was compared with regular Stearic Acid (SA) sample in SBR rubber composition. The details of the formulation is given in table-2:

TABLE 2
SBR Composition

| | | Customer supplied |
|---|---|---|
| | Control sample | sample |
| | SBR-SA | SBR-FBL |
| Ingredients | phr | Phr |
| SBR1502 | 100 | 100 |
| Zinc Oxide (ZnO) | 3 | 3 |
| Stearic Acid (SA) | 1 | 0 |
| Bleached Lanolin Fatty Acid | 0 | 1 |
| N326 (Carbon Black) | 70 | 70 |
| Aro. Oil | 15 | 15 |
| Antioxidant TDQ | 0.5 | 0.5 |
| Accelerator CBS | 1.5 | 1.5 |
| Accelerator TMTD | 1 | 1 |
| Curing Agent Sulphur | 1.5 | 1.5 |
| Accelerator CBS | 1.5 | 1.5 |

### 1.0 Properties on Unvulcanized Rubber Compound:

### Rheometric Properties:

The cure characteristics of these mixes were studied as per ASTM D5289, in a Montech Rheometer (MDR-3000) at 160° C. The curing characteristics of the materials, expressed in terms of the scorch time (tS2), Induction time (tS1), optimum cure time (t90), the maximum and minimum values of the torque (MH and ML respectively), and are tabulated in table 3.

TABLE 3
Rheometric Properties

| | | | | | Opt. Cure |
|---|---|---|---|---|---|
| | Max. | Min. | Induc. | Scorch | time |
| Sample | Torque | Torque | time | time | (Tc₉₀) |
| Code | (MH)(lbin) | (ML)(lbin) | (ts₁)min. | (ts₂) min. | min. |
| Control | 16.76 | 1.90 | 1.44 | 1.64 | 3.50 |
| SBR-FBL | 17.19 | 1.96 | 1.46 | 1.68 | 3.66 |
| (BLFA) | | | | | |

### 1.1 Mooney Viscosity:

Tests are carried out by using a Prescott Mooney Viscometer at 100° C. The testing procedure was conducted according to the method described in ASTM D1646. Observed value of Mooney Viscosity are tabulated in table-4.

TABLE 4
Mooney Viscosity

| Sample code | Observed value |
|---|---|
| Control | 55 |
| SBR-FBL (BLFA) | 59 |

### 1.2 Mooney Scorch Time

Mooney scorch time (t5) was determined by using Prescott Mooney Viscometer at 125° C. as per ASTM D1646. The Mooney scorch time (t5) is defined as the time required for an increase of five units above the minimum viscosity and determined from a plot of the Mooney viscosity versus time. Observed values of Mooney scorch time are shown in table-5.

TABLE 5
Mooney scorch time

| Sample code | Observed value |
|---|---|
| Control | 11 |
| SBR-FBL (BLFA) | 12 |

### 2 Properties on Vulcanized Rubber Compound:

For testing properties on vulcanized rubber compounds, rubber slab and other samples were cured at 160° C. as per curing time given in table-6

TABLE 6
Molding time in minutes

| | SBR-FBL |
|---|---|
| Control | (BLFA) |
| 5 | 5 |

2.1 The stress-strain properties and tear strength of the vulcanizates were measured on an Instron Universal Testing Machine, as per ASTM D412 and ASTM D624 respectively at 500 mm/min speed. The hardness was measured by the shore A Durometer according to ASTM D2240. The properties observed on vulcanizate are tabulated in following table-7.

TABLE 7
Properties on cured Sample

| | Properties | | SBR-FBL |
|---|---|---|---|
| Sr. No. | checked | Control | (BLFA) |
| i) | Modulus @100% | 22 | 23 |
| | (kg/cm²) | | |
| ii) | Modulus @200% | 57 | 59 |
| | (kg/cm²) | | |
| iii) | Modulus @300% | 100 | 97 |
| | (kg/cm²) | | |
| iv) | Tensile Strength | 147 | 147 |
| | (kg/cm²) | | |
| v) | Elongation at | 400 | 410 |
| | break (%) | | |
| vi) | Hardness (Shore | 65 | 65 |
| | A) | | |
| vii) | Tear Strength | 60 | 54 |
| | (Kg/cm) | | |

Observation: Data shows that there is no remarkable variation in properties of rubber compound filled with fatty acid and stearic acid.

### Example 2

Crude Lanolin Fatty Acid (CLFA) was evaluated in SBR rubber compound formulation and compared the properties with SA based SBR rubber composition. The details of the formulation is given in table-8

TABLE 8
SBR Composition

| | Control sample | SBR-CLFA |
|---|---|---|
| Ingredients | phr | Phr |
| SBR1502 | 100 | 100 |
| Zinc Oxide (ZnO) | 3 | 3 |
| Crude Lanolin Fatty Acid | 1 | 1 |
| N326 (Carbon Black) | 0 | 70 |
| Aro. Oil | 70 | 15 |
| Antioxidant TDQ | 15 | 0.5 |
| Antioxidant 4020 | 0.5 | 0.5 |
| Accelerator CBS | 1.5 | 1.5 |
| Accelerator TMTD | 1 | 1 |
| Curing Agent Sulphur | 1.5 | 1.5 |

### 2. Properties on Unvulcanized Rubber Compound:

### 2.1 Rheometric Properties:

The cure characteristics of these mixes were studied as per ASTM D5289, in a Montech Rheometer (MDR-3000) at 160° C. The curing characteristics of the materials, expressed in terms of the scorch time (tS2), Induction time (tS1), optimum cure time (t90), the maximum and minimum values of the torque (MH and ML respectively), and are tabulated in table 9.

TABLE 9
Rheometric Properties

| | | | | | Opt. Cure |
|---|---|---|---|---|---|
| | Max. | Min. | Induc. | Scorch | time |
| Sample | Torque | Torque | time | time | (Tc₉₀) |
| Code | (MH)(lbin) | (ML)(lbin) | (ts₁)min. | (ts₂) min. | min. |
| Control | 16.76 | 1.90 | 1.44 | 1.64 | 3.50 |
| SBR- | 15.49 | 1.56 | 1.42 | 1.61 | 3.17 |
| CLFA | | | | | |

### 2.2 Mooney Viscosity:

Tests are carried out by using a Prescott Mooney Viscometer at 100° C. The testing procedure was conducted according to the method described in ASTM D1646. Observed value of Mooney Viscosity are tabulated in table-10.

TABLE 10
Mooney Viscosity

| Sample code | Observed value |
|---|---|
| Control | 55 |
| SBR-CLFA | 52 |

### 2.3 Mooney Scorch Time

Mooney scorch time (t5) was determined by using Prescott Mooney Viscometer at 125° C. as per ASTM D1646. The Mooney scorch time (t5) is defined as the time required for an increase of five units above the minimum viscosity and determined from a plot of the Mooney viscosity versus time. Observed values of Mooney scorch time are shown in table-11.

TABLE 11
Mooney scorch time

| Sample code | Observed value |
|---|---|
| Control | 11 |
| SBR-CLFA | 12 |

### 3: Properties on Vulcanized Rubber Compound:

For testing properties on vulcanized rubber compounds, rubber slab and other samples were cured at 160° C. for 5 minutes. Molded samples are free from visible defects. Molded samples were precondition at room temperature before further testing.

The stress-strain properties and tear strength of the vulcanizates were measured on an Instron Universal Testing Machine, as per ASTM D412 and ASTM D624 respectively at 500 mm/min speed. The hardness was measured by the shore A Durometer according to ASTM D2240. The properties observed on vulcanizate are tabulated in following table-12.

TABLE 12
Properties on cured Sample

| Sr.No. | Properties checked | Control | SBR-CLFA |
|---|---|---|---|
| i) | Modulus @100% | 22 | 22 |
| | (kg/cm²) | | |
| ii) | Modulus @200% | 57 | 54 |
| | (kg/cm²) | | |
| iii) | Modulus @300% | 100 | 97 |
| | (kg/cm²) | | |
| iv) | Tensile Strength (kg/cm²) | 147 | 152 |
| v) | Elongation at break (%) | 400 | 424 |
| vi) | Hardness (Shore A) | 65 | 62 |
| vii) | Tear Strength (Kg/cm) | 60 | 57 |

### Example 3

Calcium salt of wool grease fatty acid (CA), calcium salt of wool grease fatty acid washed (CAW), magnesium salt of wool grease fatty acid (MG) were tested in SBR rubber composition. The details of the formulation is given in table-13

TABLE 13
SBR Composition

| | Material code | | |
|---|---|---|---|
| | CA | CAW | MG |
| Ingredients | Phr | phr | phr |
| SBR1502 | 100 | 100 | 100 |
| Calcium salt of | 4 | 0 | 0 |
| wool grease fatty | | | |
| acids | | | |
| Calcium salt of | 0 | 4 | 0 |
| wool grease fatty | | | |
| acids washed | | | |
| Magnesium salt of | 0 | 0 | 4 |
| wool grease fatty | | | |
| acids | | | |
| N326 (Carbon | 70 | 70 | 70 |
| Black) | | | |
| Aromatic Oil | 15 | 15 | 15 |
| Antioxidant TDQ | 0.5 | 0.5 | 0.5 |
| Antioxidant 4020 | 0.5 | 0.5 | 0.5 |
| Accelerator CBS | 1.5 | 1.5 | 1.5 |
| Accelerator TMTD | 1 | 1 | 1 |
| Curing Agent | 1.5 | 1.5 | 1.5 |
| Sulphur | | | |

### 3. Properties of Unvulcanized Rubber Compound:

3.1 Rheometric Properties: The cure characteristics of these mixes were studied as per ASTM D5289, in a Montech Rheometer (MDR-3000) at 160° C. The curing characteristics of the materials, expressed in terms of the scorch time (tS2), Induction time (tS1), optimum cure time (t90), the maximum and minimum values of the torque (MH and ML respectively), and are tabulated in table 14.

TABLE 14
Rheometric Properties

| | | | | | Opt. Cure |
|---|---|---|---|---|---|
| | Max. | Min. | Induc. | Scorch | time |
| Sample | Torque | Torque | time | time (ts2) | (Tc90) |
| Code | (MH)(lbin) | (ML)(lbin) | (ts1)min | min. | min. |
| Control | 16.76 | 1.90 | 1.44 | 1.64 | 3.50 |
| CA | 7.89 | 1.71 | 1.83 | 2.34 | 9.07 |
| CAW | 7.75 | 1.66 | 1.88 | 2.48 | 10.56 |
| MG | 6.53 | 1.71 | 1.96 | 2.46 | 7.47 |

3.2 Mooney Viscosity: Tests are carried out by using a Prescott Mooney Viscometer at 100° C. The testing procedure was conducted according to the method described in ASTM D1646. Observed value of Mooney Viscosity are tabulated in table-15.

TABLE 15
Mooney Viscosity

| Sample code | Observed value |
|---|---|
| Control | 55 |
| CA | 54 |
| CAWA | 55 |
| MG | 55 |

3.3 Mooney scorch time Mooney scorch time (t5) was determined by using Prescott Mooney Viscometer at 125° C. as per ASTM D1646. The Mooney scorch time (t5) is defined as the time required for an increase of five units above the minimum viscosity and determined from a plot of the Mooney viscosity versus time. Observed values of Mooney scorch time are shown in table-16.

TABLE 16
Mooney scorch time

| Sample code | Observed value |
|---|---|
| Control | 11 |
| CA | 17 |
| CAW | 17 |
| MG | 16 |

### 4. Properties on Vulcanized Rubber Compound:

For testing properties on vulcanized rubber compounds, rubber slab and other samples were cured at 160° C. as per curing time given in table-17.

TABLE 17
Molding time in minutes

| Control | CA | CAWA | MG |
|---|---|---|---|
| 5 | 11 | 12 | 9 |

All the molded samples are free from visible defects. Molded samples were precondition at room temperature before further testing.

The stress-strain properties and tear strength of the vulcanizates were measured on an Instron Universal Testing Machine, as per ASTM D412 and ASTM D624 respectively at 500 mm/min speed. The hardness was measured by the shore A Durometer according to ASTM D2240. The properties observed on vulcanizate are tabulated in following table-18

TABLE 18
Properties on cured Sample

| | Properties | | | | |
|---|---|---|---|---|---|
| Sr. No. | checked | Control | CA | CAWA | MG |
| i) | Modulus | 22 | 14 | 14 | 14 |
| | @100% | | | | |
| | (kg/cm²) | | | | |
| ii) | Modulus | 57 | 32 | 30 | 30 |
| | @200% | | | | |
| | (kg/cm²) | | | | |
| iii) | Modulus | 100 | 60 | 57 | 52 |
| | @300% | | | | |
| | (kg/cm²) | | | | |
| iv) | Tensile | 147 | 106 | 143 | 143 |
| | Strength | | | | |
| | (kg/cm²) | | | | |
| v) | Elongation | 400 | 442 | 536 | 599 |
| | at break | | | | |
| | (%) | | | | |
| vi) | Hardness | 65 | 58 | 58 | 58 |
| | (Shore A) | | | | |
| vii) | Tear | 60 | 52 | 54 | 49 |
| | Strength | | | | |
| | (Kg/cm) | | | | |

### Example 4: Comparative Embodiment

There are five prototype formulations were prepared separately based on hundred rubbers of styrene butadiene. Apart from SBR, each formulation is comprised of calcium salt or calcium soap of lanolin fatty acids (CA), magnesium salt or soap of lanolin fatty acids, pretreated calcium salt or soap of lanolin fatty acids, crude lanolin fatty acids, bleached lanolin fatty acid and stearic acid along with other ingredients. The percentage of ingredients in each rubber composition is given in the Table 19. The idea was to replace stearic acid and zinc oxide by directly calcium salt or magnesium salt or pretreated calcium salt of lanolin fatty acids to achieve resembling properties of uncured and cured each specimen with respect to control. Therefore, in the rubber composition/formulation, only the amount of stearic acid and zinc oxide, which were prefixed to be in the formulation was replaced by an equal amount of each salt and remaining ingredients were kept unchanged.

In case of rubber composition based on crude and bleached lanolin fatty acids, only stearic acid is replaced by crude lanolin fatty acids and bleached lanolin fatty acids, and the other ingredients were the same as used in case of control. The uncured and cured specimens from each rubber composition was evaluated for rheological and mechanical properties in comparison with the control. The uncured rheological properties using Montech Rheometer (MDR-3000) at 160° cas per ASTM D5289., Mooney viscosity using a Prescott Mooney Viscometer at 100° cas per ASTM D1646. and Mooney scorch time using Prescott Mooney Viscometer at 125° C. as per ASTM D1646, and vulcanized molding time at 160 deg C., and the cured mechanical properties using Instron Universal Testing Machine, as per ASTM D412 and ASTM D624 were determined.

TABLE 19
Comparative ingredients in per hundred rubber formulations

| | Control | | | | | |
|---|---|---|---|---|---|---|
| | sample | CA | CAWA | MG | BLFA | CLFA |
| | SBR-SA | SBR1502 | SBR1502 | SBR1502 | SBR-FBL | SBR-FBL |
| Ingredients | phr | Phr | Phr | Phr | Phr | Phr |
| SBR1502 | 100.0 | 100.0 | 100.0 | 100.0 | 100.0 | 100.0 |
| Zinc Oxide | 3.0 | 0.00 | 0.00 | 0.00 | 3.0 | 3.0 |
| (ZnO) | | | | | | |
| Stearic Acid | 1.0 | 0.00 | 0.00 | 0.00 | 0.00 | 0.00 |
| (SA) | | | | | | |
| Lanolin Fatty | 0.00 | 0.00 | 0.00 | 0.00 | 1.0 | 0.00 |
| Acids | | | | | | |
| Bleached | | | | | | |
| Crude Lanolin | 0.00 | 0.00 | 0.00 | 0.00 | 0.00 | 1.0 |
| Fatty Acids | | | | | | |
| Calcium salt of | 0.00 | 4.0 | 0.00 | 0.00 | 0.00 | 0.00 |
| Lanolin Fatty | | | | | | |
| Acids | | | | | | |
| Calcium salt of | 0.00 | 0.00 | 4.0 | 0.00 | 0.00 | 0.00 |
| Lanolin Fatty | | | | | | |
| Acids-Washed | | | | | | |
| Magnesium | 0.00 | 0.00 | 0.00 | 4.0 | 0.00 | 0.00 |
| salt of Lanolin | | | | | | |
| Fatty Acids | | | | | | |
| N326 (Carbon | 70.0 | 70.0 | 70.0 | 70.0 | 70.0 | 70.0 |
| Black) | | | | | | |
| Aro. Oil | 15.0 | 15.0 | 15.0 | 15.0 | 15.0 | 15.0 |
| Antioxidant | 0.5 | 0.5 | 0.5 | 0.5 | 0.5 | 0.5 |
| TDQ | | | | | | |
| Antioxidant | 0.5 | 0.5 | 0.5 | 0.5 | 0.5 | 0.5 |
| 4020 | | | | | | |
| Accelerator | 1.5 | 1.5 | 1.5 | 1.5 | 1.5 | 1.5 |
| CBS | | | | | | |
| Accelerator | 1.0 | 1.0 | 1.0 | 1.0 | 1.0 | 1.0 |
| TMTD | | | | | | |
| Curing Agent | 1.5 | 1.5 | 1.5 | 1.5 | 1.5 | 1.5 |
| Sulphur | | | | | | |

### Rheometric Properties of Uncured Rubber Composition.

The cure characteristics of these mixes were studied as per ASTM D5289, in a Montech Rheometer (MDR-3000) at 160° C. The curing characteristics of the materials, expressed in terms of the scorch time (tS2), Induction time (tS1), optimum cure time (t90), the maximum and minimum values of the torque (MH and ML respectively). The evaluation results for all the tested formulation are given in the Table 20.

Based on the comparative rheometric evaluation analyses, the scorch time for Control, BLFA and CLFA rubber composition specimens had shown lower values, which indicates poor shelf life due to rapid vulcanization reaction being occurred whereas in case of CA, MG and CAW rubber compositions, the scorch time has shown higher values, which indicates moderate shelf life due to delaying in-situ vulcanization reaction. However, the lower value of scorch time is related to the productivity, the productivity could be achieved in case of Control, BLFA and CLFA rubber compositions. Whereas lower the productivity in case of CA, MG and CAW and MG because of lingering the scorch time.

TABLE 20
Comparison of rheometric properties of uncured
specimens from rubber formulations.

| | | | | | Opt. |
|---|---|---|---|---|---|
| | Max. | | | Scorch | Cure |
| | Torque | Min. | Induc. | time | time |
| Sample | (M- | Torque | time | (ts₂) | (Tc₉₀) |
| Code | H)(lbin) | (ML)(lbin) | (ts₁)min. | min. | min. |
| Control | 16.76 | 1.90 | 1.44 | 1.64 | 3.50 |
| SBR- | 7.89 | 1.71 | 1.83 | 2.34 | 9.07 |
| FBL- | | | | | |
| CA | | | | | |
| SBR- | 7.75 | 1.66 | 1.88 | 2.48 | 10.56 |
| FBL- | | | | | |
| CAW | | | | | |
| SBR- | 6.53 | 1.71 | 1.96 | 2.46 | 7.47 |
| FBL- | | | | | |
| MG | | | | | |
| SBR- | 15.49 | 1.59 | 1.42 | 1.61 | 3.17 |
| FBL- | | | | | |
| CLFA | | | | | |
| SBR- | 17.19 | 1.96 | 1.46 | 1.68 | 3.66 |
| FBL- | | | | | |
| BLFA | | | | | |

Tests are carried out by using a Prescott Mooney Viscometer at 100° C.
The testing procedure was conducted according to the method described in ASTM D1646.

### Mooney Viscosity for Uncured SBR Rubber Composition:

Mooney viscosity was performed for uncured specimens by using a Prescott Mooney Viscometer at 100° C. The testing procedure was conducted according to the method described in ASTM D1646. The observed Mooney viscosity values are tabulated in the Table 21.

TABLE 21
Mooney viscosity for uncured specimens from rubber composition

| Sample name | Observed value |
|---|---|
| Control | 55.0 |
| SBR-FBL-CA | 54.0 |
| SBR-FBL-CAW | 55.0 |
| SBR-FBL-MG | 55.0 |
| SBR-FBL-CLFA | 52.0 |
| SBR-FBL-BLFA | 59.0 |

Mooney viscosity is related to the flow properties of the material whose to be processed. In all tested specimens from based on different activators was found to be nearly the same. It is clearly signified that the flow properties of all the rubber composition/formulations are same, which further give indicate to be replaced present activator like stearic acid by crude and bleached lanolin fatty acids, and also, the replacement of stearic acid and zinc oxide by CA, CAW and MG. The remarkable Mooney Viscosity values of the new raw materials could be identified as replacement for both stearic acid and zinc oxide as far the various applications are concerned.

### Mooney Scorch Time:

Mooney scorch time (t5) was determined by using Prescott Mooney Viscometer at 125° C. as per ASTM D1646. The Mooney scorch time (t5) is defined as the time required for an increase of five units above the minimum viscosity and determined from a plot of the Mooney viscosity versus time. The uncured specimens from all the rubber compounding formulations including control were tested for the Mooney Scorch Time. The observed values of Mooney Scorch Time for the rubber composition are given in the Table 22.

TABLE 22
Mooney Scorch Time for the rubber formulations

| Sample name | Observed value |
|---|---|
| Control | 11.0 |
| SBR-FBL-CA | 17.0 |
| SBR-FBL-CAW | 17.0 |
| SBR-FBL-MG | 16.0 |
| SBR-FBL-CLFA | 12.0 |
| SBR-FBL-BLFA | 12.0 |

### Properties on Vulcanized Rubber Formulation:

### Molding Time:

The molding time was determined at 160 deg C. for all the formulations including the control as per the standard protocol of the testing being executed. All the molded samples were found free from visible defects. Molded samples were precondition at room temperature before further testing. An observed values of molding time are tabulated in the Table 23.

TABLE 23
Molding Time observed values for all
the rubber composition/formulation

| Sample name | Molding Time (min) |
|---|---|
| Control | 5.0 |
| SBR-FBL-CA | 11.0 |
| SBR-FBL-CAW | 12.0 |
| SBR-FBL-MG | 9.0 |
| SBR-FBL-CLFA | 5.0 |
| SBR-FBL-BLFA | 5.0 |

Molding time determination evaluation for the rubber composition specimens is an important cured rubber formulation to understand as to how the prepared formulation gets moulded at the lowest time. Lesser the molding time the production of such formulation is rapid. Based on the determination of molding time for all tested specimen from all the prepared rubber composition the control, CLFA and BLFA have the similar values observed. In case of CA, CAW and MG the molding time is lagging this could be little less response of salts on vulcanization in comparison with the control as it has used zinc oxide and stearic acid.

Moreover, delaying the molding time indicates, the less productivity but need not pay much attention on process during molding operation. Nearly double time is required for salts than the control.

Nearly the same molding time is required for CLFA and BLFA with respect to the control, which indicates CLFA or BLFA could be used in place of stearic acid by an equal amount. Preferably CLFA as it does not require further treatment to achieve the properties and thus the cost involvement is comparatively less than the BLFA. As to obtain BLFA, requires bleaching process, which adds the cost in making of it.

### Properties of Cured Samples:

The stress-strain properties and tear strength of the vulcanizates were measured on an Instron Universal Testing Machine, as per ASTM D412 and ASTM D624 respectively at 500 mm/min speed. The hardness was measured by the shore A Durometer according to ASTM D2240. The observed values of all the formulation are tabulated in the Table 24.

TABLE 24
Properties of cured samples:

| | | | SBR- | SBR- | SBR- | SBR- | SBR- |
|---|---|---|---|---|---|---|---|
| | Properties | | FBL- | FBL- | FBL- | FBL- | FBL- |
| Sr. No. | checked | Control | CA | CAW | MG | CLFA | BLFA |
| 1 | Modulus | 22.0 | 14.0 | 14.0 | 14.0 | 22.0 | 23.0 |
| | @100% | | | | | | |
| | (kg/cm²) | | | | | | |
| 2 | Modulus | 57.0 | 32.0 | 30.0 | 30.0 | 54.0 | 59.0 |
| | @200% | | | | | | |
| | (kg/cm²) | | | | | | |
| 3 | Modulus | 100.0 | 60.0 | 57.0 | 52.0 | 97.0 | 97.0 |
| | @300% | | | | | | |
| | (kg/cm²) | | | | | | |
| 4 | Tensile | 147.0 | 106.0 | 143.0 | 143.0 | 152.0 | 147.0 |
| | Strength | | | | | | |
| | (kg/cm²) | | | | | | |
| 5 | Elongation | 400.0 | 424.0 | 536.0 | 599.0 | 424.0 | 410.0 |
| | at break (%) | | | | | | |
| 6 | Hardness | 65.0 | 58.0 | 58.0 | 58.0 | 62.0 | 65.0 |
| | (Shore A) | | | | | | |
| 7 | Tear | 60.0 | 52.0 | 54.0 | 49.0 | 57.0 | 54.0 |
| | Strength | | | | | | |
| | (Kg/cm) | | | | | | |

Tensile strength of SBR formulation based on CA was found to be lower than other samples tested. Elongation at break of SBR formulation based on CAW and MG is higher than other samples tested. Hardness for CA, CAW and MG is lower than BLFA, CLFA and the control. Hardness could be improved by either adding more quantity of Carbon or decrease the quantity of Aromatic oil.

### Example 5: Synthesis of Magnesium Salt of Lanolin Fatty Acids

A 100 g of distilled lanolin fatty acids, which were produced using short path distillation, took in a 2-liter 4 neck round bottom flask and placed in temperature-controlled water. The flask was equipped with overhead stirrer, water condenser, the thermometer pocket and the addition funnel. To this flask added 14.9 g NaOH and 400 ml methanol as diluent. The entire assembly was immersed in water bath and slowly increased batch temperature from room temperature to 68.0 deg C. within 30 min span while stirring and circulating water in condenser. The neutralization reaction was performed for 4 h under stirring at the set reflux temperature 68.0 deg C. In this process, the neutralization of lanolin fatty acid and the same time saponification of small amount ester in lanolin fatty acids have been occurred. The accomplishment of reaction has been confirmed by achieving acid value of reaction less than 0.5 mg KOH/g. The double decomposition was carried out using 17.6 g anhydrous magnesium chloride (MgCl2) in 200 ml methanol at 68 deg C. under stirring for 2.0. The reaction completion was determined by withdrawing sample and filtered using paper. The filtrate was further tested for precipitation using magnesium chloride solution. After confirmation of metathesis reaction and cooling the reaction mass, carried out filtration with the help of buckner funnel and the buckner flask under vacuum at 50 deg C. The solids on buckner funnel as magnesium salt or magnesium soap of lanolin fatty acids was further washed with 200 ml fresh methanol two times. The washed magnesium soap was then dried at 50 deg C. using Rotavac under vacuum. The uttermost care was taken to avoid escape of solids in receiver by placing in vapour tube. The drying was executed until the salt showed loss on drying less than 0.25%. The main filtrate and washing were mixed, and methanol was recovered. A 110 g of light brown coloured dried salt or soap lanolin fatty acids were obtained and evaluated in styrene butadiene rubber composition against stearic acid and zinc oxide. The analysis of magnesium salt or magnesium soap of lanolin fatty acids is tabulated in Table 25.

TABLE 25
Analysis of magnesium salt of lanolin fatty acids

| Sr No. | Parameters | Results |
|---|---|---|
| 1 | Appearance | Light brown powder |
| 2 | Free Fatty Acid (%) | 0.89 |
| 3 | Moisture (%) | 0.2 |
| 4 | Ash Content as MgO (%) | 5.1 |
| 5 | Magnesium Content (%) | 3.1 |

### Example 6: Chemical Bleaching of Lanolin Fatty Acids-Process

1. Weighed a 100.0 g of crude lanolin fatty acids in a cleaned 1000.0 ml, 4 neck round bottom flak. Attached overhead stirrer, a 100.0 ml capacity an addition funnel and other two necks were kept open to atmosphere. Placed the entire assembly in water bath.
2. Slowly increased the temperature in order to reach temperature of mass at 80.0-85.0 deg C. and maintained the same throughout the experiment.
3. Started an agitator when the crude fatty acids were completely melted into liquid form.
4. Read the TDS and MSDS of hydrogen peroxide for personal safety and handling, it is strong oxidative agent and forms an exotherm when comes in contact with other raw materials and chemicals.
5. It has to be stored in dark, cool place and away from reactive chemicals and raw materials.
6. Calculated the amount of Hydrogen Peroxide (Approx. 50.0% strength) based on weight of crude fatty acids and divided into four parts.
7. Used 10.0% (v/w) hydrogen peroxide based on crude lanolin fatty acids.
8. Carefully transfer each part of Hydrogen Peroxide into an addition funnel.
9. Started slowly addition of Hydrogen Peroxide drop wise (0.2 to 0.3 ml/min) for 30 min and allowed to react it for 60 min under stirring. The foam was seen in the mass when the addition completed but the foam was ceased at certain time.
10. Again, carefully transfer 2nd part of hydrogen peroxide into addition funnel and added dropwise into the mass for 30.0 min and stirred further for 60.0 min.
11. Similarly, 3rd and 4th parts were also added and allowed to stir.
12. The total time for addition and stirring was 6.0 h.
13. Dried the product mass (Bleached Lanolin Fatty Acids) under reduced pressure at 75.0-80.0 deg C. under continuous stirring.
14. Sent the sample to Analysis Department for PV analysis as per AOCS Official Method
15. PV should be less than 20.0 meq/kg, if it shows higher value than expected then continue the drying process.
16. Allowed to cool the mass at 60.0-65.0 deg C. and drained the bleached fatty acids into sample bottle once the PV is assured.

The analyses of crude lanolin fatty acids and bleached lanolin fatty acids are given in the Table 26 and Table 27, respectively.

TABLE 26
Analysis of crude lanolin fatty acids

| Sr. No. | Test | Results |
|---|---|---|
| 1 | Description | Dark brownish waxy solid |
| 2 | Acid Value (mg KOH/g) | 96.4 |
| 3 | Saponification Value (mg | 135.1 |
| | KOH/g) | |
| 4 | Iodine Value (g/100g) | 28.4 |
| 5 | Ash Content (% w/w) | 0.07 |
| 6 | Moisture Content (% w/w) | 0.5 |
| 7 | Melting Range (deg C.) | 38.0 to 40.0 |

TABLE 27
Analysis of bleached lanolin fatty acids

| Sr. No. | Test | Results |
|---|---|---|
| 1 | Description | Pale Yellow to Yellowish Brown |
| | | Waxy Solid |
| 2 | Acid Value (mg KOH/g) | 85.0 |
| 3 | Saponification Value (mg | 146.9 |
| | KOH/g) | |
| 4 | Iodine Value (g/100 g) | 24.8 |
| 5 | Ash Content (% w/w) | 0.07 |
| 6 | Moisture Content (% w/w) | 0.15 |
| 7 | Melting Range (deg C.) | 38.0 to 40.0 |
| 8 | Peroxide Value (meq/kg) | 5.0 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

We claim:

1. A rubber composition for industrial application comprising;
i. A diene rubber selected from natural rubber (NR), styrene-butadiene rubber (SBR) or butadiene rubber (BR);
ii. By-products based on renewable source selected from calcium salt of lanolin fatty acid (CA), magnesium salt of lanolin fatty acids (MG), pretreated calcium salt of lanolin fatty (CAW) or crude lanolin fatty acids (CLFA) and bleached lanolin fatty acids (BLFA) alone or mixtures thereof; and
iii. Additives which include but not restricted to Carbon Black, Aromatic Oil, Antioxidants, Accelerators and Curing Agent.

2. The rubber composition as claimed in claim 1, wherein the rubber composition comprises;
i. Styrene butadiene rubber (SBR) in an amount of 100 per hundred rubber ranging between 50-52% of total composition;
ii. By-products based on renewable source selected from calcium salt of lanolin fatty acid (CA), magnesium salt of lanolin fatty acids (MG), pretreated calcium salt of lanolin fatty (CAW) or crude lanolin fatty acids (CLFA) and bleached lanolin fatty acids (BLFA) in an amount of 0.5 to 5.0%, and 1.0 to 6% per hundred rubbers, respectively, alone or mixtures thereof; and
iii. Additives which include but not restricted to Carbon Black, Aromatic Oil, Antioxidants, Accelerators and Curing Agent in an amount of 40 to 47% per hundred rubbers.

3. The rubber composition as claimed in claim 1, wherein the pre-treated calcium salt of lanolin fatty acids (CAW) is prepared by a process comprising;
i. Alkaline hydrolysis of Lanolin or wool grease or wool wax in presence of lower alcohol at elevated temperature to obtain potassium and/or sodium salt of lanolin fatty acid, unreacted free alkali, lower chain alcohol-methanol, and the lanolin alcohols;
ii. Converting the potassium and/or sodium salt of lanolin fatty acid to metallic soap or calcium soap of lanolin fatty acids and filtering followed by drying; and
iii. Recovering the solvent from the filtrate by distillation under vacuum.

4. The rubber composition as claimed in claim 1, wherein the magnesium salt of lanolin fatty acids (MG) is prepared by the process comprising;
i. Alkaline hydrolysis and saponification of distilled Lanolin fatty acids containing small amount of ester in presence of anhydrous magnesium chloride;
ii. Filtering, cooling and drying to obtain magnesium salt or magnesium soap of lanolin fatty acids.

5. The rubber composition as claimed in claim 1, wherein the bleached lanolin fatty acid (BLFA) is prepared by the process comprising;
i. Melting the crude lanolin fatty acid at a temperature ranging between 80-85° C.;
ii. Treating the melted crude lanolin fatty acid with 10% v/w hydrogen peroxide based on crude lanolin fatty acids in parts for a time period of 5-7 hours followed by drying the Bleached Lanolin Fatty Acid under reduced pressure at 75.0-80.0° C. and cooling to obtain the desired product.

6. The rubber composition as claimed in any one of the preceding claims 1 to 5 for use in various industrial application like tyre, conveyor belts, rubber sheets and the like.
